(19) United States
(12) Patent Application Publication
(10) Pub. No.: US 2003/0236399 A1
(43) Pub. Date: Dec. 25, 2003

(54) Method of improving the quality of taste of natural sweetner

(75) Inventors: Shu Wang Zheng, Jining (CN); Guang San Che, Jining (CN); Shao Lang Zhou, Jining (CN); Qiang Huo, Jining (CN)

Correspondence Address: Raymond Y. Chan, Suite 128, 108 N. Ynez Ave., Monterey Park, CA, 91754, US

(73) Assignee: Shangdong Hua Xian Stevia Co., Ltd.

(21) Appl. No.: 10/601,951

(22) Filed: Jun. 23, 2003

(30) Foreign Application Priority Data
Jun. 25, 2002 (CN) 02135141.4

(51) Int. Cl. C13K 5/00

(52) U.S. Cl. 536/123.13

(57) ABSTRACT

The present invention is a method of improving the quality of taste of a sweetener such as stevioside comprising the steps of (a) providing a predetermined aqueous solution of Stevioside; (b) adding a predetermined substrate with a predetermined dextrose equivalent (D.E.) (c) mixing the aqueous solution of stevioside and substrate; (d) adding a predetermined transferase in a predetermined quantity to form a reacting solution; and (e) allowing the reacting solution to react for a predetermined reaction time under a predetermined controlled temperature to form a resulting product. Taking consideration of the production cost and percentage yield of the product, a predetermined set of reaction conditions are selected such that the percentage yield of 60-86% is achieved and the qualities of the taste of the sweentener such as the quality of sweetness, the pleasantness, the after-taste, the similarity to sucrose are improved.

### BACKGROUND OF THE PRESENT INVENTION

1. Field of Invention

The present invention relates to a process of improving the taste of quality of natural sweetener, and more particularly to a process of improving the quality of taste of a natural sweetener, which is extracted from Stevia Rebaudiana Bertoni.

2. Description of Related Arts

Stevioside is a glycoside found in a perennial herbs in the Chrysanthemum family, Stevia Rebaudiana Bertoni, which is native to Paraguay in the South America. Stevia Rebaudiana Bertoni consists of components with the property of sweetness which include stevioside, rebaudioside (A, B, C, D, and E), and dulcoside A. These components combine with the steviol structure as a glycoside. The major components contributing the property of sweetness of Stevia Rebaudiana Bertoni are steviode which has a molecular weight of 804.9 with melting point between 196-198° C. and rebaudioside A which has a molecular weight of 967.0 with melting point between 242-244° C. Stevioside is stable in structure under the conditions of high temperature, high acidity and high alkalinity. Stevioside is a natural glycoside/sugar being extracted and used as a natural sweetener and the sweetness level of stevioside is 200-300 times higher than that of sucrose while the calories of stevioside is 200-300 times lower than that of sucrose. As the standard of living of human being is higher, the selection and use of sweeteners are not only playing an important role in our everyday lives but also in the food products, drinks, medical and health industry. Nowadays, as a result of high consumption of sucrose and lactose, health problems such as diabetes, obesity and heart disease have become a great social problem in our society. Artificial chemical sweetener, such as sacchrine, has been manufactured and used to reduce the health problem induced by high consumption of sucrose and lactose. However, because of its hazardous side effects along with its carcinogenic effect, the use of sacchine as sweetener was limited and controlled in the developed countries, such as Europe and the United States.

Stevia Rebaudiana Bertoni has been widely used in different industries in many countries and regions for more than 20 years. The countries include China, Japan, Korea, Singapore, Taiwan, Indonesia, the United States of America, and the South America. Stevia Rebaudiana Bertoni has been used in products of food industry, healthy drinks, medicine, alcoholic drinks, and sauce.

Although Stevia Rebaudiana Bertoni is originated from Paraguay in the South America, more than 85% of its growing and production area is in China and more than 90% of the produce are exported from China to other countries.

The major component stevioside of Stevia Rebaudiana Bertoni has a higher level of sweetness than sucrose. However, apart from its high level of sweetness of stevioside, it has also inherent properties of post-bitter taste and unpleasant and undesirable after-taste. At present, there are four major methods being used to improve the quality of taste of stevioside. The first method is organic solvent distillation such as with the use of medical alcohol as solvent to increase the quality of the taste. However, since alcohol is used in the process, any residue alcohol will pose harm to human body. Moreover, the yield of production is low which highly increases the production cost while and the unpleasant after-taste persists. The second method is using resin to improve the quality of the taste of stevioside wherein the second method involves washing the resin with acid and alkaline solution and the resin will attach to the stevioside in the production process which leads to relative low yield while the unpleasant after-taste problem remains unsolved. The third method involves adding amino acid group to the stevioside to improve the quality of taste. However, since a large quantities of amino acid is required in the production process, it results in increasing calories value, and destroying the low calories characteristic of stevioside. Besides, the cost of amino acid is high which in turn highly increase the production cost of stevioside. The forth method is combining the use of stevioside with glucose, sucrose and lactose which process a higher quality of taste. However, since a large quantity of additional sugar such as glucose is required, it will destroy the natural characteristic of stevioside while the quality of taste is still unpleasant.

Thus, the above four methods in fact cannot solve the fundamental problems and is accessory means to improve the quality of the taste of Stevioside. All these improvement method do not involve the process of improving the structure of Stevioside.

U.S. Pat. No. 4,219,571 discloses a process for producing a sweetener involving a process which allows glucosyltransferase to react with stevioside in an aqueous solution in order to transform the stevioside into an alpha-glycosyl stevioside and hence improve the quality of taste of stevioside by altering the structure of stevioside. Referring to the disclosed experimental founding of the U.S. patent '571, the quality of the taste of the stevioside is obviously improved. However, the U.S. patent '571 in fact just indicates the feasibility of further scientific research as the conditions and requirement of the reaction are not definite and clear. For example, it states that the reactant of the process is an aqueous solution of 0.1% to 20% stevioside and the concentration of α-glucosyltransferase is ranged from 1% to 50% in the process, that is to say, the ratio of α-glucosyltransferase and stevioside is ranged from 0.5 to 500 which is a very board value. Besides, the DE value of α-glucosyltransferase is in the range of 10 and 70, the pH value is in the range of 3 and 10, the temperature requirement is in the range of 20 and 80, and the reaction time is in the range of 5 and 80 hours. All these conditions are indefinite for a reaction. Since the range of the conditions and requirement of the reaction is too large, it is impossible to define the preferred embodiment of the invention definitely if we do not take any further steps to break through the existing technology. It is especially important to have a definite process to produce a high yield and low cost sweetener for industrial use and maximize the economical contribution.

### SUMMARY OF THE PRESENT INVENTION

A main object of the present invention is to provide a process of improving the quality of a natural sweetener which is capable of defining the optimize conditions for large scale industrial production.

Another object of the present invention is to provide a process of forming alpha-glycosyl stevioside (α-glycosyl stevioside) from stevioside which is suitable for mass production.

Another object of the present invention is to provide a process of forming alpha-glycosyl stevioside (α-glycosyl stevioside) from stevioside, wherein the yield is capable of being maximize and the cost is capable of being minimize for industrial production.

Another object of the present invention is to provide a process of forming alpha-glycosyl stevioside (α-glycosyl stevioside) from stevioside which clearly defines the conditions of the process, wherein the yield resulted from the reaction is capable of being maximized and the cost of production is capable of being minimized for industrial production.

Accordingly, in order to accomplish the above objects, the present invention is to provide a process of improving the taste of quality of a natural sweetener consisting the steps of:

a) providing a predetermined aqueous solution of stevioside having a predetermined concentration;

b) providing a predetermined substrate with a predetermined dextrose equivalent (D.E.) and a predetermined concentration, wherein the quantity of the stevioside and the substrate is capable of being added to define as predetermined reactants;

c) providing a predetermined transferase in a predetermined quantity so as to maintain a predetermined ratio of transferase and reactants;

d) mixing the predetermined substrate, the predetermined transferase and the predetermined aqueous solution of stevioside; and

e) allowing the predetermined substrate, the predetermined transferase, and the predetermined aqueous solution to react for a predetermined time under a predetermined temperature.

These and other objectives, features, and advantages of the present invention will become apparent from the following detailed description, the accompanying drawings, and the appended claims.

### DETAILED DESCRIPTION OF THE PREFERRED EMBODIMENT

The present invention is to provide a process of improving the taste of quality of a natural sweetener consisting the steps of:

a) providing a predetermined aqueous solution of stevioside having a predetermined concentration;

b) providing a predetermined substrate with a predetermined dextrose equivalent (D.E.) and a predetermined concentration, wherein the quantity of the stevioside and the substrate is capable of being added to define as predetermined reactants;

c) providing a predetermined transferase in a predetermined quantity so as to maintain a predetermined trasferase ratio of the transferase and the reactants;

d) mixing the predetermined substrate, the predetermined transferase and the predetermined aqueous solution of stevioside, wherein the predetermined substrate, the predetermined transferase and the predetermined aqueous solution of stevioside are defined as starting materials before mixing; and

e) allowing the predetermined substrate, the predetermined transferase, and the predetermined aqueous solution to react for a predetermined reaction time under a predetermined controlled temperature to form a resulting product, namely α-glycosyl stevioside.

In order to analyze the percentage yield of the above process, we may have an additional step of analyzing the resulting product to define a predetermined percentage yield of the process, wherein the percentage yield is an indication of the completion of the reaction of the process which changes stevioside to α-glycosyl stevioside.

The above process of improving the taste of quality of a natural sweetener is capable of having a predetermined percentage yield by providing a predetermined condition of the process. The scope of the predetermined condition of the process are illustrated below.

The process of achieving a 60-80% percentage yield is under the conditions of having a 10-18% aqueous solution of stevioside, a 10-19% substrate with DE value 4-30, a trasferase ratio of 0.06-0.25%, a controlled temperature within 40-80° C., and a reaction time within 3-30 hours.

The process of achieving a 70-86% percentage yield is under the conditions of having a 13-16% aqueous solution of stevioside, a 13-15% substrate with DE value 4-20, a trasferase ratio of 0.09-0.22%, a controlled temperature within 55-80° C., and a reaction time within 9-18 hours.

The process of achieving a 82-86% percentage yield is under the conditions of having a 13-16% aqueous solution of stevioside, a 13-15% substrate with DE value 4-20, a trasferase ratio of 0.09-0.22%, a controlled temperature within 66-78° C., and a reaction time within 10-18 hours.

According to the above examples of predetermined conditions, the cost of production is increased by 12% while the value of the resulting product is dramatically increased by 50%. This gives a great economical advantage together with a structural change of the stevioside to improve the nature of the quality of taste.

Comparisons have been made between the natural sweetener before and after the process of the present invention and the results are illustrated as follow:

| Sweetness Equivalent | Before the process of the | After the process of the |
|---|---|---|
| (Compare with sucrose) | present invention | present invention |
| Equivalent to 5% sucrose | Sweet, Bitter, no unpleasant | Improve sweetness, pleasant, |
| solution | after-taste, relatively | taste similar to sucrose, no |
| | insoluble under ambient | unpleasant after-taste, easy to |
| | temperature, inconvenience | dissolve under ambient |
| | to use | temperature, convenience to |
| | | use |
| Equivalent to 10% sucrose | Sweet, higher level of | Improve sweetness, pleasant, |
| | bitterness, relatively | taste similar to sucrose, no |
| solution | insoluble under ambient | unpleasant after-taste, easy to |
| | temperature | dissolve under ambient |
| | | temperature, convenience to |
| | | use |
| Equivalent to 15% sucrose | Sweet, irritative, very high | High quality of sweetness, |
| solution | level of bitterness, | pleasant, taste similar to |
| | inconvenience to use | sucrose, no unpleasant after- |
| | | taste, easy to dissolve under |
| | | ambient temperature, |
| | | convenience to use |

After a full range of analysis, the first preferred embodiment of the process of the present invention comprising the steps of:

a) providing a predetermined aqueous solution of stevioside having a predetermined concentration;

b) adding a predetermined substrate with a predetermined dextrose equivalent (D.E.) and a predetermined concentration to the aqueous solution of stevioside, wherein the quantity of the stevioside and the substrate is capable of being added to define as predetermined reactants;

c) mixing the aqueous solution of stevioside and substrate thoroughly such that the substrate is completely dissolved to form a starting solution;

d) adding a predetermined transferase in a predetermined quantity to the starting solution to form a reacting solution;

e) allowing the reacting solution to react for a predetermined reaction time under a predetermined controlled temperature to form a resulting product.

One skilled in the art will understand that the disclosure of conventional skill is required and that not all the conventional skills are required to be described.

According to the process of the invention as described above, a table of different examples of the first preferred embodiment is illustrated and summarized as below:

| | | | DE value | | Controlled | Reaction | |
|---|---|---|---|---|---|---|---|
| | Concentration | Concentration | of | Transferase | temperature | time | Percentage |
| Examples | of stevioside | of substrate | substrate | ratio | (° C.) | (Hours) | yield |
| 1 | 14 | 15 | 16 | 0.18 | 66 | 18 | 86 |
| 2 | 16 | 13 | 12 | 0.1 | 75 | 14 | 78 |
| 3 | 12 | 11 | 6 | 0.17 | 55 | 16 | 82 |
| 4 | 18 | 19 | 20 | 0.2 | 80 | 9 | 75 |
| 5 | 13 | 14 | 14 | 0.15 | 75 | 12 | 83 |

The substrate used in the process of the first preferred embodiment of the present invention is alpha-glucosyl sugar compound such as starch, dextrin, cyclodextrin and the likes while the respective types of transferase are glucosyltransferase, cyclodextrin glucanotransferase and the likes. One skilled in the art will understand the complimentary use of the substrate and the transferase in respect to the substrate.

One skilled in the art will understand that the embodiment of the present invention described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A process of improving the quality of taste of a natural sweetener for mass production comprising the steps of:
a) providing a predetermined stevioside in aqueous solution having a predetermined concentration;
b) adding a predetermined substrate with a predetermined dextrose equivalent (DE) and a predetermined concentration to said stevioside, wherein the quantity of said stevioside and the substrate is capable of being added to define as predetermined reactants wherein said substrate is a alpha-glucosyl sugar compound;
c) mixing said stevioside and said substrate thoroughly such that said substrate is completely dissolved to form a starting solution;
d) adding a predetermined transferase in a predetermined quantity to said starting solution to form a reacting solution; and
e) allowing said reacting solution to react for a predetermined reaction time under a predetermined controlled temperature to form a resulting product wherein said resulting product is α-glycosyl stevioside; whereby said resulting product gives a percentage yield between 75 and 86.

2. The process, as recited in claim 1, wherein said alpha-glucosyl sugar compound is selected from the group of starch, dextrin and cyclodextrin.

3. The process, as recited in claim 1, wherein said transferase is selected from the group of glucosyltransferase and cyclodextrin glucanotransferase.

4. The process, as recited in claim 2, wherein said transferase is selected from the group of glucosyltransferase and cyclodextrin glucanotransferase.

5. The process, as recited in claim 1, wherein said concentration of stevioside, said concentration of substrate, said DE value of said substrate, said transferase ratio, said controlled temperature, said reaction time are in the range of 10 and 18%, 10 and 19%, 4 and 30, 0.06 and 0.25%, 40° C. and 80° C., and 3 and 30 hours respectively.

6. The process, as recited in claim 5, wherein said alpha-glucosyl sugar compound is selected from the group of starch, dextrin and cyclodextrin.

7. The process, as recited in claim 6, wherein said transferase is selected from the group of glucosyltransferase and cyclodextrin glucanotransferase.

8. The process, as recited in claim 1, wherein said concentration of stevioside, said concentration of substrate, said DE value of substrate, said transferase ratio, said controlled temperature, said reaction time are in the range of 13 and 16%, 13 and 15%, 4 and 20, 0.09 and 0.22%, 55° C. and 80° C., and 9 and 18 hours respectively.

9. The process, as recited in claim 8, wherein said alpha-glucosyl sugar compound is selected from the group of starch, dextrin and cyclodextrin.

10. The process, as recited in claim 9, wherein said transferase is selected from the group of glucosyltransferase and cyclodextrin glucanotransferase.

11. The process, as recited in claim 1, wherein said concentration of stevioside, said concentration of substrate, said DE value of substrate, said transferase ratio, said controlled temperature, said reaction time are in the range of 13 and 16%, 13 and 15%, 4 and 20, 0.09 and 0.22%, 66° C. and 78° C., and 10 and 18 hours respectively.

12. The process, as recited in claim 11, wherein said alpha-glucosyl sugar compound is selected from the group of starch, dextrin and cyclodextrin.

13. The process, as recited in claim 12, wherein said transferase is selected from the group of glucosyltransferase and cyclodextrin glucanotransferase.

14. The process, as recited in claim 1, wherein said concentration of stevioside, said concentration of substrate, said DE value of substrate, said transferase ratio, said controlled temperature, said reaction time are in the range of 12 and 14%, 11 and 19%, 6 and 20, 0.1 and 0.2%, 55° C. and 80° C., and 9 and 18 hours respectively so as to give a percentage yield between 75 and 86.

15. The process, as recited in claim 14, wherein said alpha-glucosyl sugar compound is selected from the group of starch, dextrin and cyclodextrin.

16. The process, as recited in claim 15, wherein said transferase is selected from the group of glucosyltransferase and cyclodextrin glucanotransferase.

17. The process, as recited in claim 1, wherein said concentration of stevioside, said concentration of substrate, said DE value of substrate, said transferase ratio, said controlled temperature, said reaction time are 14%, 15%, 16, 0.18%, 66° C., and 18 hours respectively so as to give a percentage yield of 86.

18. The process, as recited in claim 4, wherein said concentration of stevioside, said concentration of substrate, said DE value of substrate, said transferase ratio, said controlled temperature, said reaction time are 14%, 15%, 16, 0.18%, 66° C., and 18 hours respectively so as to give a percentage yield of 86.

19. A process of improving the quality of taste of stevioside for mass production comprising the steps of:
a) providing an aqueous solution of stevioside having a predetermined concentration;
b) providing a predetermined substrate with a predetermined dextrose equivalent and a predetermined concentration, wherein the quantity of said stevioside and said substrate is defined as predetermined reactants and said substrate is a alpha-glucosyl sugar compound;
c) mixing said aqueous solution of stevioside and said substrate to form a starting solution;
d) adding a predetermined transferase in a predetermined quantity to said starting solution to form a reacting solution; and
e) allowing said reacting solution to react for a predetermined reaction time under a predetermined controlled temperature to form a resulting product wherein said resulting product is α-glycosyl stevioside; wherein said alpha-glucosyl sugar compound is selected from the group of starch, dextrin and cyclodextrin and said transferase is selected from the group of glucosyltransferase and cyclodextrin glucanotransferase whereby said resulting product gives a substantially high percentage yield for mass production.

20. The process, as recited in claim 19, wherein said concentration of stevioside, said concentration of substrate, said dextrose equivalent value of substrate, said transferase ratio, said controlled temperature, said reaction time are 14%, 15%, 16, 0. 18%, 66° C., and 18 hours respectively such that said percentage yield is 86.
